(19) United States
(12) Patent Application Publication
(10) Pub. No.: US 2009/0159145 A1
(43) Pub. Date: Jun. 25, 2009

(54) HOSE WITH COMPOSITE LAYER

(75) Inventor: Aaron K. Amstutz, Peoria, IL (US)

Correspondence Address: Caterpillar Inc.;Intellectual Property Dept., AH 9510, 100 N.E. Adams Street, PEORIA, IL, 61629-9510, US

(73) Assignee: Caterpillar Inc., Peoria, IL (US)

(21) Appl. No.: 11/959,513

(22) Filed: Dec. 19, 2007

(51) Int. Cl. F16L 11/00

(52) U.S. Cl. 138/126; 138/153; 138/129

(57) ABSTRACT

A hose with a length dimension is disclosed, the hose including a wall with a composite layer, the composite layer including cushion material and support material, the support material including a plurality of successive sublayers oriented such that each of the sublayers at least partially overlaps at least one other sublayer along any axis substantially perpendicular to the length dimension of the hose.

### TECHNICAL FIELD

This invention generally relates to a hose that includes a composite layer with multiple overlapping sublayers.

### BACKGROUND

In a hydraulic or other fluid system, a hose configured to carry the fluid may be subjected to external and internal stresses during installation and use. Specifically, in order to connect components in the fluid system to one another, such a hose may be subjected to the external stresses of being bent from its naturally longitudinal shape and maintained in the bent position. Further, such a hose may be subjected to the internal stresses of carrying fluid being pumped at high pressure. A hose may be designed to reduce the strain caused by these stresses, thereby reducing hose wear, and may further be designed to reduce the degree of external stress necessary to bend the hose to a desired shape. Such designs may be implemented, for instance, by utilizing hose architecture that includes multiple layers and/or materials of varying elasticity in varying configurations.

U.S. Pat. No. 4,106,967 to Logan et al. (“Logan et al.”) discloses a variety of hose designs, including designs with one or more helically wrapped layers of elastomeric matrix material and designs with corrugations and helically wrapped wire supporting the corrugations. Although such designs may enhance the structural integrity of the hose and thereby protect against collapse and rupture, they may not provide the degree of stress compliance desired for enhanced hose bendability and enhanced tolerance of high fluid pressure.

### SUMMARY OF THE INVENTION

A hose with a length dimension is disclosed, the hose including a wall with a composite layer, the composite layer including cushion material and support material, the support material including a plurality of successive sublayers oriented such that each of the sublayers at least partially overlaps at least one other sublayer along any axis substantially perpendicular to the length dimension of the hose.

A hose with a length dimension is disclosed, the hose including first and second peripheral layers and a composite layer between the first peripheral layer and the second peripheral layer. The composite layer includes cushion material and support material. The support material of the composite layer includes a plurality of successive sublayers defining a helix, each of the sublayers at least partially overlapping at least one other sublayer along any axis substantially perpendicular to the length dimension of the hose.

A hose with a length dimension is disclosed, the hose including first and second peripheral layers and a composite layer between the first peripheral layer and the second peripheral layer. The composite layer includes cushion material and support material. The support material of the composite layer includes a plurality of successive sublayers defining a helix, each of the sublayers at least partially overlapping at least one other sublayer along any axis substantially perpendicular to the length dimension of the hose, the sublayers within every pair of adjacent sublayers being spaced apart by the cushion material of the composite layer.

### BRIEF DESCRIPTION OF THE DRAWINGS

FIG. 1 is a perspective view of a partially cut away hose according to an embodiment of the invention; and

FIG. 2 is a cross-sectional view of the hose shown in FIG. 1, taken through line 2-2 of FIG. 1.

### DETAILED DESCRIPTION

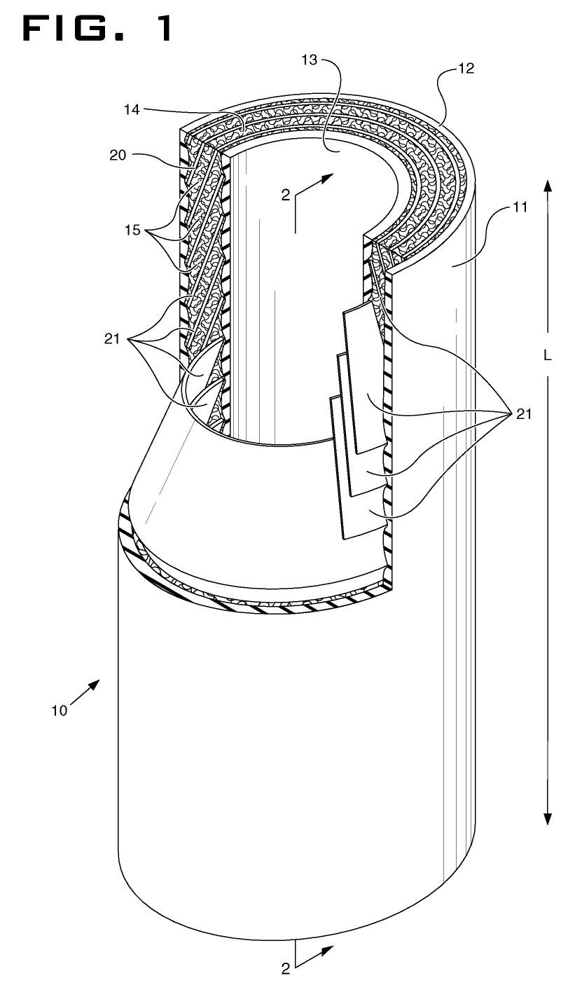

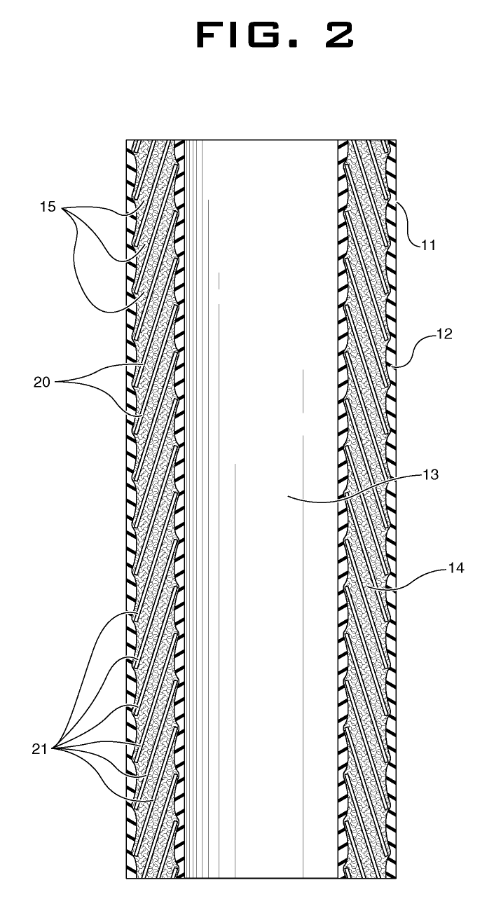

A hose according to an embodiment of the invention is shown broadly in FIG. 1 at reference numeral 10. However, the detailed description of the disclosed embodiment of the invention will proceed with reference to both FIG. 1 and FIG. 2. The hose 10 has a length dimension “L” and includes a wall 11 that includes first and second peripheral layers 12, 13 and a composite layer 14 between the first and second peripheral layers 12, 13. The composite layer 14 includes cushion material 15 and support material 20. The support material 20 of the composite layer 14 includes a plurality of successive sublayers 21 oriented such that each of the sublayers 21 at least partially overlaps at least one other sublayer along any axis substantially perpendicular to the length dimension “L” of the hose 10. In the disclosed embodiment, each of the sublayers 21 of the support material 20 overlaps two other sublayers along any axis substantially perpendicular to the length dimension “L” of the hose 10. In addition, the plurality of sublayers 21 form a helix and the sublayers 21 within every pair of adjacent sublayers 21 comprised by the support material 20 are spaced apart by the cushion material 15.

The following materials and architecture are contemplated for use in the disclosed embodiment of the invention. The first and second peripheral layers 12, 13 as well as the cushion material 15 may be formed of one or more varieties of rubber and/or rubber compounds. The first peripheral layer 12 may be flame retardant and resistant to abrasion, sunlight, and ozone, while the second peripheral layer 13 may be resistant to oil. The cushion material 15 may have a lower elastic modulus than the support material 20. The support material 20 may be formed of steel or a composite comprising high-strength carbon fiber, fiberglass, aramid, and/or other high modulus polymeric fiber. As used herein, the term “high-strength” means having a yield strength of at least approximately 500 megapascals (MPa) and the term “high modulus” means having a modulus of at least approximately 70 gigapascals (GPa). The wall 11 of the hose 10 may have a thickness equal to approximately twenty percent (20%) of the inner diameter of the hose 10. The minimum inner diameter of the hose 10 may be approximately ¼ inch. The first and second peripheral layers 12, 13 may each comprise approximately twenty percent (20%) of the thickness of the wall 11 while the composite layer 14 may comprise approximately the remaining sixty percent (60%) of the thickness of the wall 11. Overall, the hose 10 may be rated to sustain pressures of between approximately two thousand (2,000) and approximately ten thousand (10,000) pounds per square inch (p.s.i.) and the ratio between the burst pressure and the rated pressure of the hose 10 may be approximately 4:1.

The hose 10 may be manufactured in accordance with multi-layer hose manufacturing methods known by those of ordinary skill in the art, for instance by wrapping the various layers of the hose 10 in succession on a mandrel (not shown).

### INDUSTRIAL APPLICABILITY

When carrying fluid (not shown) at high pressure, the composite layer 14 of the wall 11 of the hose 10 elastically compresses in order to damp and absorb the shock and stress internally imparted to the hose 10 by the fluid. Similarly, when the hose 10 is crimped or bent, the composite layer 14 of the wall 11 of the hose 10 elastically compresses in order to damp and absorb the shock and/or stress externally imparted to the hose 10 by the crimping and bending forces. In both these cases, the cushion material 15 of the composite layer 14 of the hose 10, with its relatively low elastic modulus, elastically deforms to damp and absorb the forces acting on the hose 10 while the support material 20 of the composite layer 14 of the hose 10 maintains the strength and structural integrity of the hose 10 and helps to urge the hose 10 back to its undeformed shape when the forces described above are no longer acting on the hose 10. These properties of the hose 10 are particularly suited to hydraulic applications, which frequently involve high pressure fluid and hose bends.

Many variations of the disclosed embodiments of the invention may be practiced without departing from the scope of the invention. For instance, in lieu of forming a helix, the support material 20 in the composite layer 14 of the hose 10 may be formed of multiple nested frustoconical bodies (not shown) separated from one another by the cushion material 15. In addition, the first and second peripheral layers 12, 13 of the hose 10 may comprise between approximately two and six plies of material. In any event, the potential embodiments of the invention disclosed above are provided only as examples and do not abridge the scope of the invention, as the full scope of the invention is defined only by the claims.

What is claimed is:

1. A hose with a length dimension, the hose comprising:
a wall including a composite layer, the composite layer comprising cushion material and support material, the support material including a plurality of successive sublayers oriented such that each of the sublayers at least partially overlaps at least one other sublayer along any axis substantially perpendicular to the length dimension of the hose.

2. A hose according to claim 1, wherein the sublayers within every pair of adjacent sublayers comprised by the support material are spaced apart by the cushion material.

3. A hose according to claim 1, wherein each of the sublayers overlaps two other sublayers along any axis substantially perpendicular to the length dimension of the hose.

4. A hose according to claim 1, wherein the plurality of successive sublayers in the support material define a helix.

5. A hose according to claim 1, wherein the elastic modulus of the cushion material of the composite layer is lower than the elastic modulus of the support material of the composite layer.

6. A hose according to claim 5, wherein the cushion material is rubber and the support material is metal.

7. A hose according to claim 5, wherein the cushion material is rubber and the support material is a composite comprising high-strength fiber.

8. A hose according to claim 1, including first and second peripheral layers, wherein the composite layer is between the first peripheral layer and the second peripheral layer.

9. A hose according to claim 8, wherein the composite layer encompasses approximately 60% of a thickness of the wall of the hose.

10. A hose with a length dimension, comprising:
first and second peripheral layers; and
a composite layer between the first peripheral layer and the second peripheral layer, the composite layer comprising cushion material and support material, the support material including a plurality of successive sublayers defining a helix, each of the sublayers at least partially overlapping at least one other sublayer along any axis substantially perpendicular to the length dimension of the hose.

11. A hose according to claim 10, wherein the sublayers within every pair of adjacent sublayers comprised by the support material are spaced apart by the cushion material.

12. A hose according to claim 10, wherein each of the sublayers overlaps two other sublayers along any axis substantially perpendicular to the length dimension of the hose.

13. A hose according to claim 10, wherein the elastic modulus of the cushion material of the composite layer is lower than the elastic modulus of the support material of the composite layer.

14. A hose according to claim 13, wherein the cushion material is rubber and the support material is metal.

15. A hose according to claim 13, wherein the cushion material is rubber and the support material is a composite comprising high-strength fiber.

16. A hose with a length dimension, comprising:
first and second peripheral layers; and
a composite layer between the first peripheral layer and the second peripheral layer, the composite layer comprising cushion material and support material, the support material including a plurality of successive sublayers defining a helix, each of the sublayers at least partially overlapping at least one other sublayer along any axis substantially perpendicular to the length dimension of the hose, the sublayers within every pair of adjacent sublayers being spaced apart by the cushion material.

17. A hose according to claim 16, wherein each of the sublayers overlaps two other sublayers along any axis substantially perpendicular to the length dimension of the hose.

18. A hose according to claim 16, wherein the elastic modulus of the cushion material of the composite layer is lower than the elastic modulus of the support material of the composite layer.

19. A hose according to claim 18, wherein the cushion material is rubber and the support material is metal.

20. A hose according to claim 18, wherein the cushion material is rubber and the support material is a composite comprising high-strength fiber.
